(19) United States
(12) Patent Application Publication
(10) Pub. No.: US 2025/0045411 A1
(43) Pub. Date: Feb. 6, 2025

(54) SYSTEM AND METHOD FOR CONTINUOUS AUTOMATED THREAT MODELING

(71) Applicant: Guardian Life Insurance Company of America, New York, NY (US)

(72) Inventors: Manas Singh, Chappaqua, NY (US); Karan Pratap Singh, Edison, NJ (US); Naveen Kumar S, Tamil Nadu (IN); Daniel Johnson, Slingerlands, NY (US); Greg Kyrytschenko, Seymour, CT (US); Michael Novack, Wilmington, DE (US); Srini Vuttarapally, Allentown, PA (US)

(73) Assignee: Guardian Life Insurance Company of America, New York, NY (US)

(21) Appl. No.: 18/230,253

(22) Filed: Aug. 4, 2023

(51) Int. Cl. G06F 21/57; G06F 21/55

(52) U.S. Cl. CPC G06F 21/577; G06F 21/552

(57) ABSTRACT

A system and method for continuous automated threat modeling which is based on prompt engineering using large language models includes a threat modeling engine, a threat prompt generator, and a continuous automation module configured to retrieve a threat prompt from the threat prompt generator and to perform a security assessment of the threat prompt on a continuous, automatic basis. In addition, the system and method each include integration with a large language model for generating threat models and mitigations pertaining to those threat models.

### TECHNICAL FIELD

This disclosure relates to threat modeling and, more particularly, to systems and methods for continuous automated threat modeling.

### BACKGROUND

Threat modeling is a structured representation of information that lets users and/or administrators understand security vulnerabilities of a computer application or a computer system. That is, threat modeling is a systematic approach used in cybersecurity settings to identify, assess, and mitigate potential risks and vulnerabilities in software systems, application, and/or networks. Threat modeling involves analyzing a system's architecture, functionality, and potential threats to understand the system's security posture. Threat modeling enables informed decision-making regarding security controls, countermeasures, and validations.

Prior to this disclosure, attempts to reduce problems from creating accurate and useful threat models came in forms of one-off activities done during a system's design phase or manual processes that involved little to no automation. These traditional forms of threat modeling can be time-consuming, resource-intensive, and subject to both human biases and human mistakes. Traditional forms of threat modeling have led to outdated threat assessments, reactive (rather than proactive) security measures, and inabilities with adapting to rapidly evolving threats.

### SUMMARY OF THE DISCLOSURE

In one implementation, a system for continuous automated threat modeling based on prompt engineering using large language models is based on a threat modeling engine configured to ingest an application profile, a workload context, and a software template. The system includes the threat modeling engine generating a threat model after ingesting the application profile, the workload context, and the software template, a threat prompt generator comprising a prompt generation pipeline, a large language model integrated with the prompt generation pipeline and configured to generate a threat prompt, wherein the threat prompt is based off an annotated threat configuration, a threat taxonomy, and a prompt template, and a continuous automation module, wherein the continuous automation module retrieves the threat prompt and performs a security assessment of the threat prompt.

One or more of the following features may be included. The system may include a threat artifact generator in communication with the threat model engine. The system may include the annotated threat configuration comprising a third-party threat intelligence program. The system may include the continuous automation module comprising a code generator in communication with the large language model. The system may include the threat modeling engine further comprising a threat engine orchestrator in communication with a threat configuration composer, one or more threat artifacts, and a Relative Attacker Attractiveness analyzer. The system may include the threat modeling engine generating the one or more threat artifacts and the Relative Attacker Attractiveness analyzer. The system may include the Relative Attacker attractiveness analyzer receiving information from a threat and risk catalog and the threat engine orchestrator, analyzing the information, generating a percentage value, then sending the percentage value to a threat score generator. The system may include the threat prompt generator further comprising a prompt template composer configured to compose a threat prompt template, save the threat prompt template in a threat template repository, obtain an annotation from a threat data annotator, communicate with a threat taxonomy database, and send information to a prompt generation pipeline. The system may include the prompt generation pipeline being configured to query and train the large language model with the threat prompts. The system may include the continuous automation module further comprising a policy generator in communication with the large language model. The system may include the continuous automation module further comprising automatic and continuous generation of at least one threat report that is communicated to the threat modeling engine. The system may include the large language model being integrated with a policy generator and a code generator. The system may include the continuous automation module further comprising the large language model developing policies and code via queries and training from prior threat reports and/or prior threat prompts. The system may include the continuous automation module further comprising a template patching notification.

In another implementation, a method for continuous automated threat modeling based on prompt engineering using large language models is based on ingesting an application profile, a workload context, and a software template; identifying potential threats and vulnerabilities of a system; annotating a threat configuration; incorporating data that mitigates the potential threats and vulnerabilities of the system; generating a threat prompt based off an annotated threat configuration, a threat taxonomy, a prompt template, and prompt engineering; integrating a large language model; and enabling continuous automation of the system via automatic retrieval of the threat prompt and automatic performance of a security assessment on the threat prompt.

One or more of the following features may be included. The method may include generating threat artifacts based on the identified potential threats and vulnerabilities of the system. The method may include the threat prompt being based on fine-tuning, a sampling strategy, and a diversity algorithm.

In another implementation, a computer-readable medium storing instructions that, when executed by a computing device, causes the device to perform a method for continuous automated threat modeling based on prompt engineering using large language models has the method including ingesting an application profile, a workload context, and a software template; identifying potential threats and vulnerabilities of a system; annotating a threat configuration; incorporating data that mitigates the potential threats and vulnerabilities of the system; generating a threat prompt based off an annotated threat configuration, a threat taxonomy, a prompt template, and prompt engineering; integrating a large language model; and enabling continuous automation of the system via automatic retrieval of the threat prompt and automatic performance of a security assessment on the threat prompt.

The details of one or more implementations are set forth in the accompanying drawings and the description below. Other features and advantages will become apparent from the description, the drawings, and the claims.

### BRIEF DESCRIPTION OF THE DRAWINGS

Various embodiments in accordance with the present disclosure be described with reference to the drawings, in which:

FIG. 1 illustrates an example of a system for continuous automated threat modeling based on prompt engineering using large language models.

FIG. 2 illustrates an example of a method for continuous automated threat modeling based on prompt engineering using large language models.

FIG. 3 illustrates an example of an application profile.

FIG. 4 illustrates an example of a workload context.

FIG. 5 illustrates an example of a software template.

FIG. 6 illustrates an example of a threat report.

FIG. 7 illustrates an example of an enhanced threat report.

FIG. 8 illustrates an example of a threat prompt composer.

FIG. 9 illustrates an example of a threat prompt generation pipeline.

FIG. 10 illustrates an example of security tests.

### DETAILED DESCRIPTION OF THE PREFERRED EMBODIMENTS

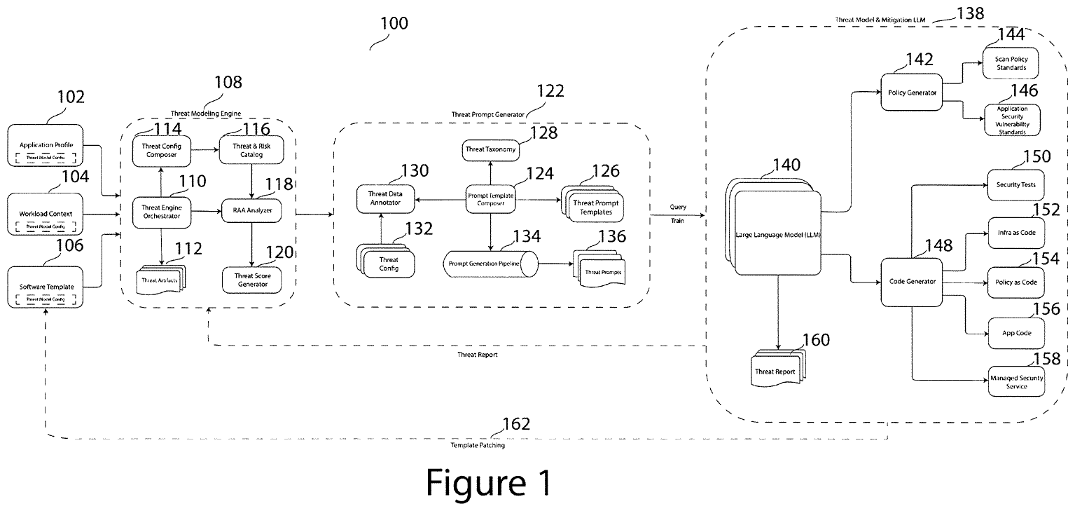

Referring to FIG. 1, there is shown a system for continuous automated threat modeling 100. An application profile 102, a workload context 104, and a software template 106 may be ingested by threat modeling engine 108 to enable a threat engine orchestrator 110 in threat modeling engine 108 to generate threat artifacts 112 based off of ingested information. Threat artifacts 112 may include a threat artifact generator in communication with threat modeling engine 108, in which the threat artifact generator generates additional threat-based information to be included within threat artifacts 112

Application profile 102 may include, but is not limited to, policies and guidelines for a particular application; attributes pertaining to the application profile's 102 privacy risk; protected health information (“PHI”); personally identifiable information (“PII”); key or significant financial systems for obtaining and recording financial information; externally-facing features; business critical system attributes service-level agreements; and computer-system availability, among other application profile components which, for example, may include information from customer databases.

Workload context 104 may include information related to workloads in a computing environment. A workload may be an application, a software, or a program. A workload may also refer to the amount of work that software imposes on underlying computing resources. A workload context may include, but is not limited to, information surrounding an application and its resources, such as service-level agreements, computing platform and version, workload type (e.g., virtual, container, serverless, etc.), cloud characteristics, deployment type, contents of a service list, and characteristics related to processing (e.g., central processing unit, or CPU) and memory resources.

Software template 106 may include, but is not limited to, a programming language (e.g., python), a version number, a software framework (e.g., a micro web framework written in a particular programming language), an assets directory, a threat framework (e.g., a model for identifying computer security threats, such as STRIDE or PASTA or LINDDUN), a dependency file (e.g., a text file), a software type (e.g., frontend or backend), an application programming interface (API) type (e.g., REST, GraphQL, gRPC, etc.), a threshold for test coverage, access types for one or more databases, one or more messaging queues, and one or more storage queues, acceptable data formats (e.g., XML or JSON), and required security tests (e.g., denial of service, CPU cycle theft, ransomware, identity theft, theft of PII, database compromises, cross site scripting, etc.).

Continuing with FIG. 1, threat modeling engine 108, after ingesting information from application profile 102, workload context 104, and software template 106 (all of which may be configured as inputs by a system user or a system administrator), may have threat engine orchestrator 110 automatically generate a threat model via, for example, threat artifacts 112 via a threat configuration composer 114 that references a threat & risk catalog 116. The threat engine orchestrator 110 may then provide generated threat artifacts 112 in conjunction with information from the threat & risk catalog 116 to a Relative Attacker Attractiveness Analyzer (RAA Analyzer 118) to obtain a percentage value pertaining to the likelihood of an attack on any aspect of the ingested information. A threat score generator 120 may summarize the analysis of RAA Analyzer 118 by generating a threat score and its underlying information for review.

Threat modeling engine 108, after generating threat artifacts 112 and providing a threat score from threat score generator 120 and one or more threat models based on, for example, threat artifacts 112, may exchange information with a threat prompt generator 122, which may include a prompt template composer 124, one or more threat prompt templates 126, a threat taxonomy 128 database configured to consider classifications of threat-related information, a threat data annotator 130 configured to annotate threat prompts, one or more threat configurations 132, and a threat prompt generation pipeline 134 configures to generate and distribute threat prompts 136 (for instance, threat prompts 136 may ultimately be based on, among other things, using the weights of an already trained network as starting values for training a new network; a sampling strategy; and/or a diversity algorithm) to a threat model & mitigation large language model (LLM) 138.

Prompt template composer 124 may obtain information from threat modeling engine 108 to compose prompt templates ready to proceed through prompt generation pipeline 134. Prompt template composer may exchange information with threat prompt templates 126, with threat prompt templates 126 being located, for example, in a software repository that may be called a threat template repository. Prompt template composer 124 may use templates from the repository in conjunction with threat taxonomy 128, with threat taxonomy 128 including, but not limited to, categories or classifications of threats for informing prompt template composer 124 of those categories or classifications to provide either standard or unique solutions against threats. Prompt template composer 124 may also combine information from threat taxonomy 128 with information from threat data annotator 130 to provide threat prompts that act in accordance with parameters either set by a user or are readable by large language model 140 (e.g., in consideration of fine-tuning, sampling strategies, diversity algorithms, etc.). One or more threat configurations 132 may be modified to control what parameters threat data annotator 130 may focus, prioritize, or consider in its annotation activities.

Prompt template composer 124 may, following any interaction with any component of threat prompt generator 122, exchange a prompt template with prompt generation pipeline 134. The prompt template may include generated threat prompts and/or security tests for mitigating and validating issues (e.g., given-when-then format for writing down test cases) posed by the generated threat prompts. Prompt generation pipeline 134 may be a set of data processing elements connected in a series, where the output of one element is the input of the next element. Prompt generation pipeline 134 may also comprise a sequence of computing processes (commands, program runs, tasks, threads, procedures, etc.). In operation, prompt generation pipeline 134 may import an API from any programming language (e.g., OpenAI through HTTP requests via Python bindings, Node.js, etc.), import a module (e.g., OS module in Python, Python's random module), import a data serialization language (e.g., YAML), and/or file formats (e.g., JSON). With imported items, prompt generation pipeline 134 may then search an environment for a calling process (e.g., via the function getenv( )), obtain a required security test based off prompt template composer 124, use Python with statements to open a software template or the required security test as a string or a stream, and employ loops (e.g., for . . . with loops) to generate responses as threat prompts 136 that may be readable by large language model 140.

Threat prompts 136 from prompt generation pipeline 134 may then be sent to threat model & mitigation LLM 138 in the form of one or more queries (e.g., tests) and/or one or more trainings (for training large language model 140) and may thereby include prompt engineering techniques (e.g., crafting, priming, refining, or probing prompts within a scope or within the capabilities of, for example, large language model 140). Prompt engineering may be performed manually by a user or administrator, or automatically within system 100 and/or large language model 140. Threat prompt generation pipeline 134 may be integrated with large language model 140 while generating a threat prompt based on, for example, information from threat taxonomy 128, threat data annotator 130 (e.g., which may include annotations derived within system 100 or from a third-party intelligence program source), and/or prompt templates 126. Large language model 140 may use one or more threat prompts 136 to develop one or more mitigations with regards to contents of the one or more threat prompts 136. Large language model 140 may, for instance, generate code (e.g., via code generator 148) to either update code present in a computer system or to adjust security controls in the computer system. Code generator 148 may generate security tests 150, infrastructure as code 152 (i.e., the managing and provisioning of infrastructure through code instead of through manual processes), policy as code (e.g., writing code in a language to manage and automate policies, such as automatic testing and automatic deployment policies), application code 156, and/or managed security services 158 (e.g., services that have been outsourced to a service provider or include third-party intelligence data or at least one third-party threat intelligence program). Large language model 140 may also, for instance, generate policies (e.g., via policy generator 142) to control security and risk management of a system. Policy generator 142 may generate scan policy standards 144 and/or application security vulnerability standards 146. Large language model 140 may, either independently or in conjunction with information from items generated by policy generator 142 and/or code generator 148, generate one or more threat reports 160. The one or more threat reports 160 may then, via a continuous automation module (not shown in FIG. 1), retrieve the threat prompt and perform a security assessment of the threat prompt and send either the security assessment or the one or more threat reports 160 (or both near-simultaneously) to threat modeling engine 108 to continuously and automatically perform additional threat modeling (e.g., in a loop-like manner; developing queries and training from prior threat reports and/or prior threat prompts; etc.).

Threat model and Mitigation LLM 138 may also provide information pertaining to template patching 162 (e.g., via a template patching notification which may contain patching information or a lack of necessary patching thereof), which a system administrator may use as a notification to patch software template 106 and to further strengthen or improve system 100 in performing its continuous automated threat modeling functionality.

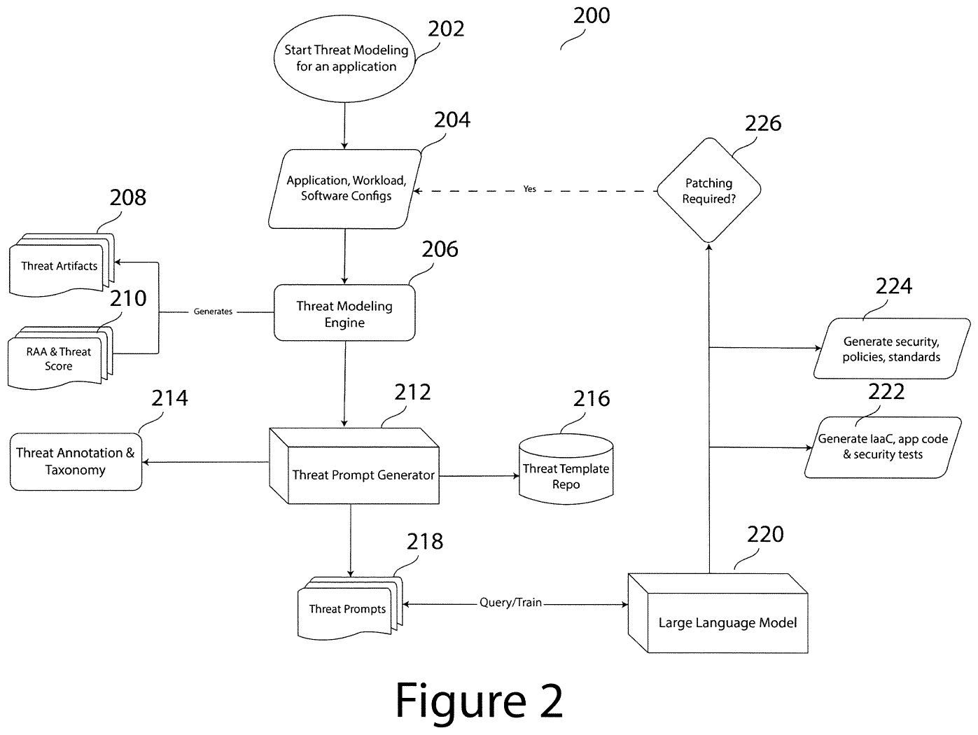

Referring to FIG. 2, there is shown a method flowchart of a method for continuous automated threat modeling 200. Operation of the system begins when a user or administrator starts threat modeling for an application (step 202). The user or administrator then provides information pertaining to an application, a workload, and one or more software configurations (step 204) and prepares the information to be send to a threat modeling engine (step 206). The threat modeling engine may include the same components as threat modeling engine 108 depicted in FIG. 1. The threat modeling engine in step 206 may then generate threat artifacts (step 208) and values stemming from a relative attacker attractiveness analyzer and a threat score (step 210). A threat prompt generator may then obtain information generated or derived from the threat modeling engine, as well as from threat annotation and taxonomy frameworks (step 214) and threat templates from a repository (step 216), to generate threat prompts (step 218). The threat prompt generator may generate threat prompts with the same system components as those depicted in threat prompt generator 122 in FIG. 1. The threat prompts may then be exchanged with a large language model via queries or trainings (step 220). The large language model may also generate its own threat prompts based on the threat prompts it receives. The large language model may also generate infrastructure as code, application code, and/or security tests (step 222) to mitigate threats posed by threat prompts. The large language model may also generate security policies and standards for a system (step 224) to better protect the system against threats contemplated by threat prompts. Following step 224, information pertaining to patching the application (e.g., including a notification to a user or administrator about patching), the workload, and the one or more software configurations in step 204 may be apparent to the user or the administration, in which case a system administrator may patch software to further strengthen or improve the system in performing its continuous automated threat modeling functionality.

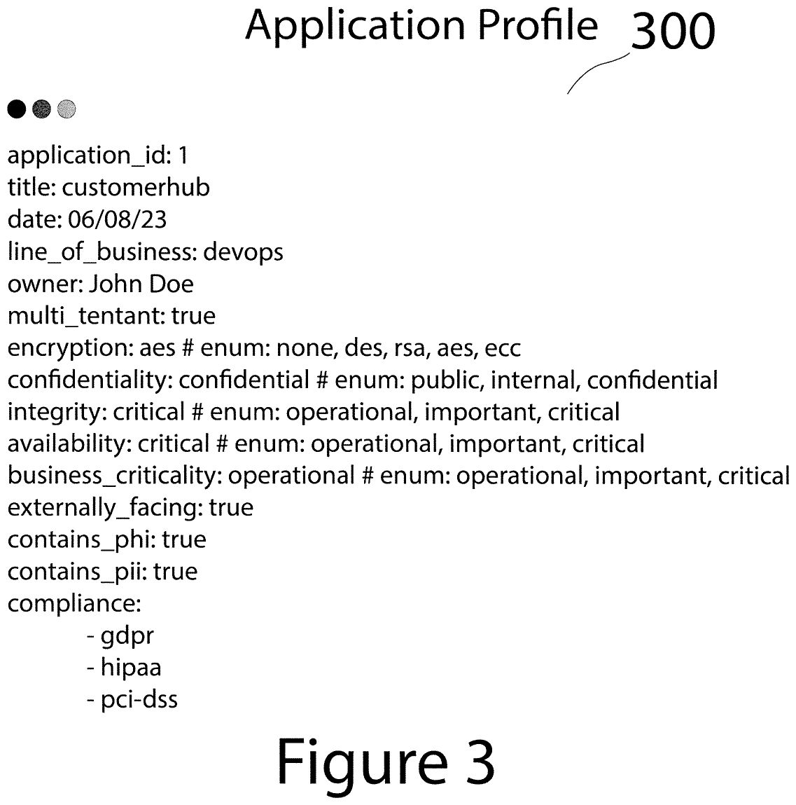

Referring to FIG. 3, there is shown an embodiment of an application profile 300 containing information, in a script, which is to be ingested by a threat modeling engine. Application profile 300 may have encryption information (e.g., data encryption standard, Rivest-Shamir-Adleman, advanced encryption standard, elliptic curve cryptography, etc.), a confidentiality level, an integrity level, an availability level, a business criticality level, sensitive customer information, and a list of data privacy standards (e.g., general data protection regulation, health insurance portability and accountability act, etc.).

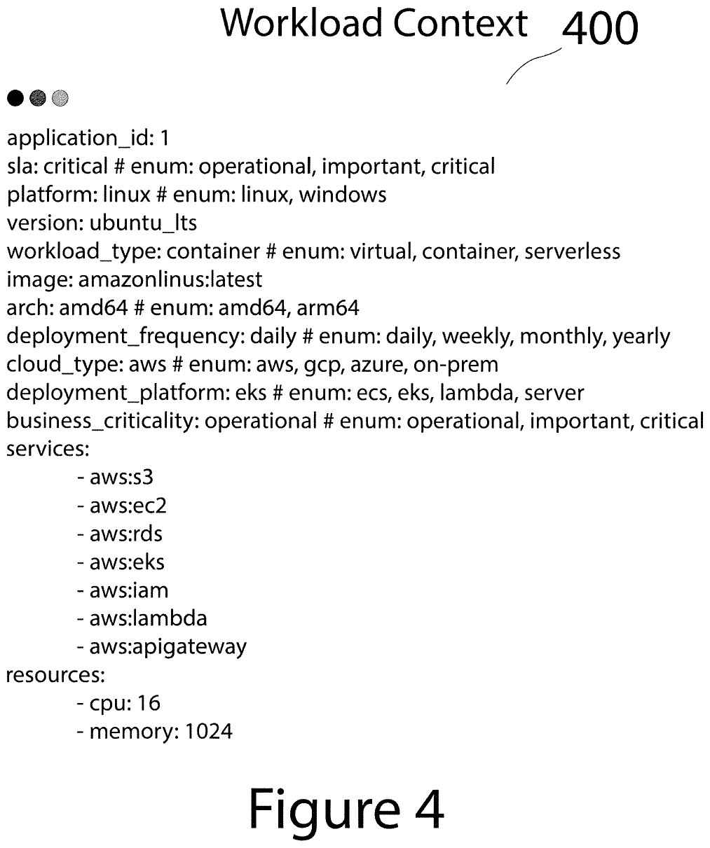

Referring to FIG. 4, there is shown an embodiment of a workload context 400 containing information, in a script, which is to be ingested by a threat modeling engine. Workload context 400 may include a service level agreement criticality level, platform and version information, workload type(s), a docker image, Linux distribution information (e.g., arch), deployment frequency, cloud type (e.g., Amazon Web Services, Google Cloud Platform, Azure, or no cloud type [i.e., on premises]), deployment platform information (e.g., Amazon ECS, Amazon EKS, Amazon Lambda, or another server), a list of cloud services, and/or CPU and memory resource information.

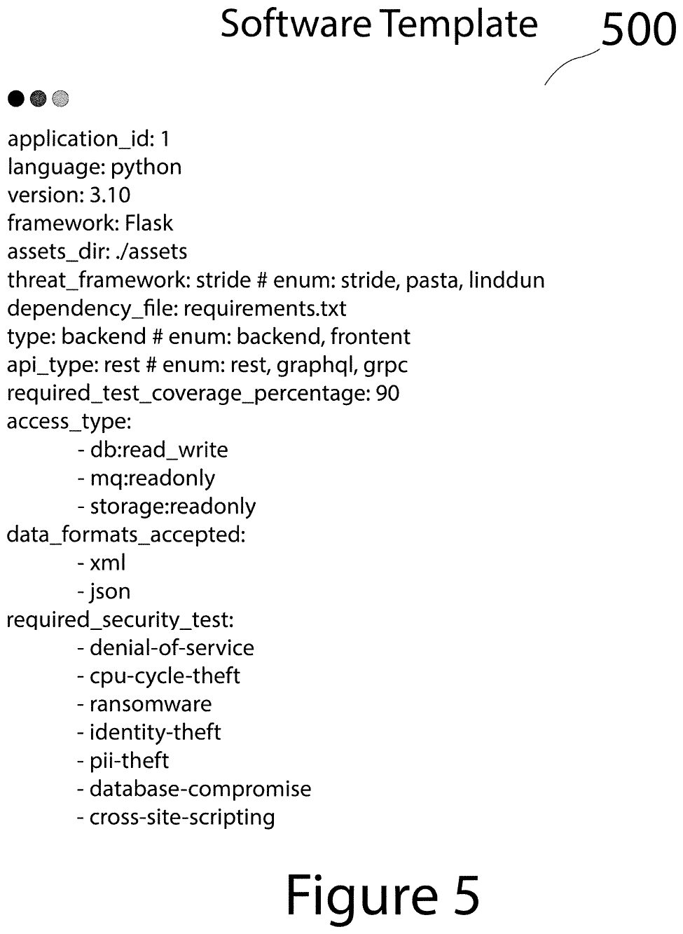

Referring to FIG. 5, there is shown an embodiment of a software template 500 containing information, in a script, which is to be ingested by a threat modeling engine. Software template 500 may include a programming language category, a version number, a software framework (e.g., Flask or another framework written in another programming language), assets directory information, a threat framework (e.g., STRIDE, PASTA, LINDDUN, etc.), dependency file information, classification information for a frontend or a backend software template, API type (e.g., REST, GraphQL, gRPC, etc.), information on a required test coverage percentage for a software unit, a list of access types, a list of accepted data formats, and a list of one or more required security tests.

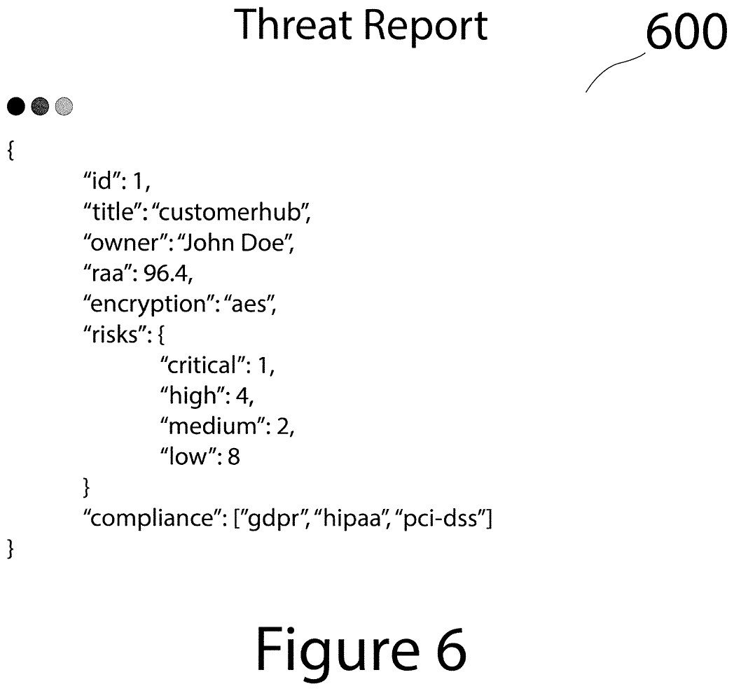

Referring to FIG. 6, there is shown an embodiment of a threat report 600 that is to be employed by a continuous automation module of a system to query and train a large language model as well as provide information to a threat modeling engine. The threat report 600 may include a percentage value representing a piece of information's attractiveness to potential attacker (e.g., Relative Attacker Attractiveness, or “RAA”), the piece of information's risks, and the piece of information's compliance standards.

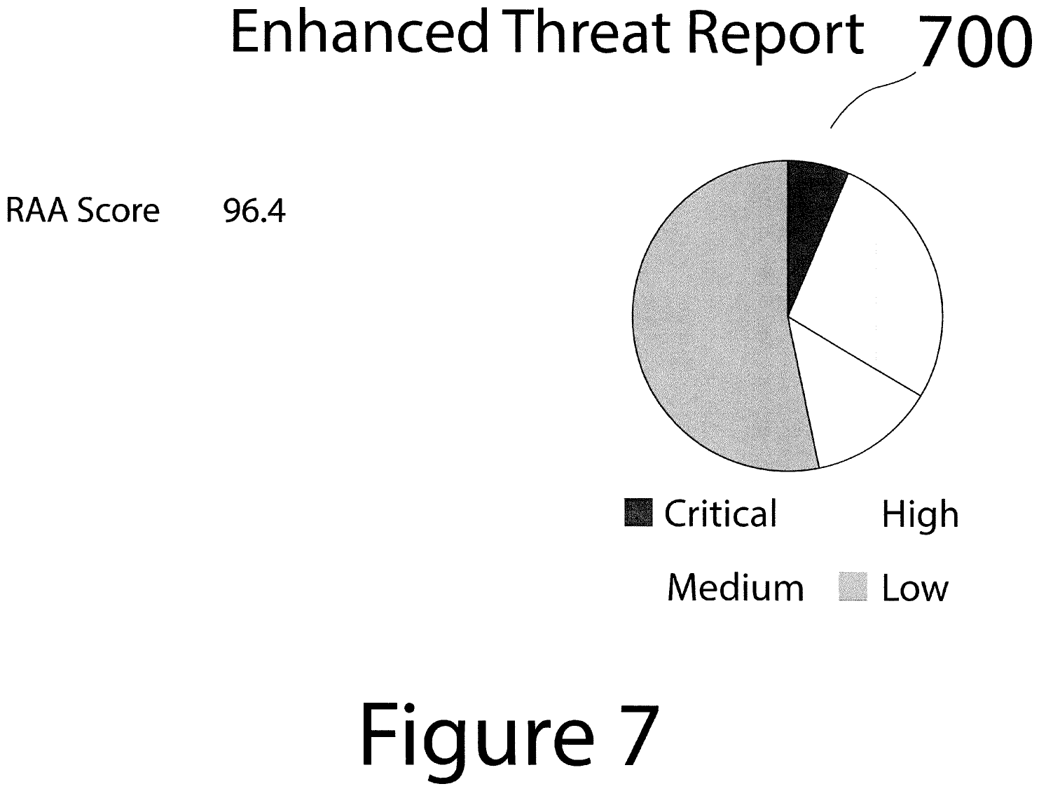

Referring to FIG. 7, there is shown an embodiment of an enhanced threat report 700 that is to be employed by a continuous automation module of a system to query and train a large language model as well as provide information to a threat modeling engine. The enhanced threat report 700 may substantially comprise information found in threat report 600, with the exception of a pie chart to graphically depict risks posed by whatever information enhanced threat report 700 pertains to.

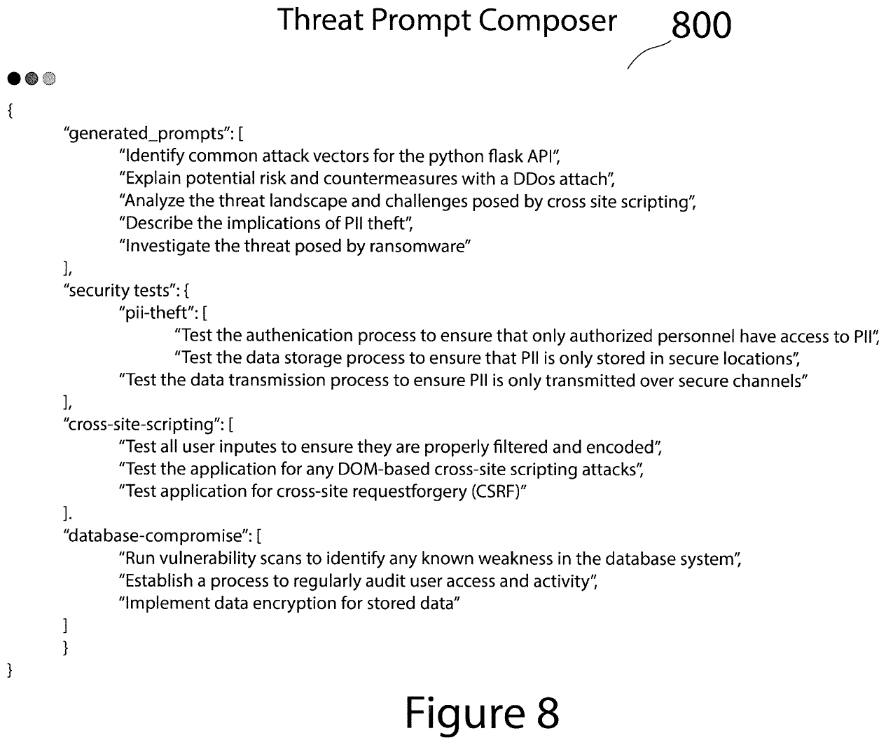

Referring to FIG. 8, there is shown an embodiment of a prompt template composer or a threat prompt composer 800. Threat prompt composer 800 may include generated prompts, security tests, prompts related to cross site scripting, and/or prompts related to database compromises, either from a system administrator or from a large language model or from both sources.

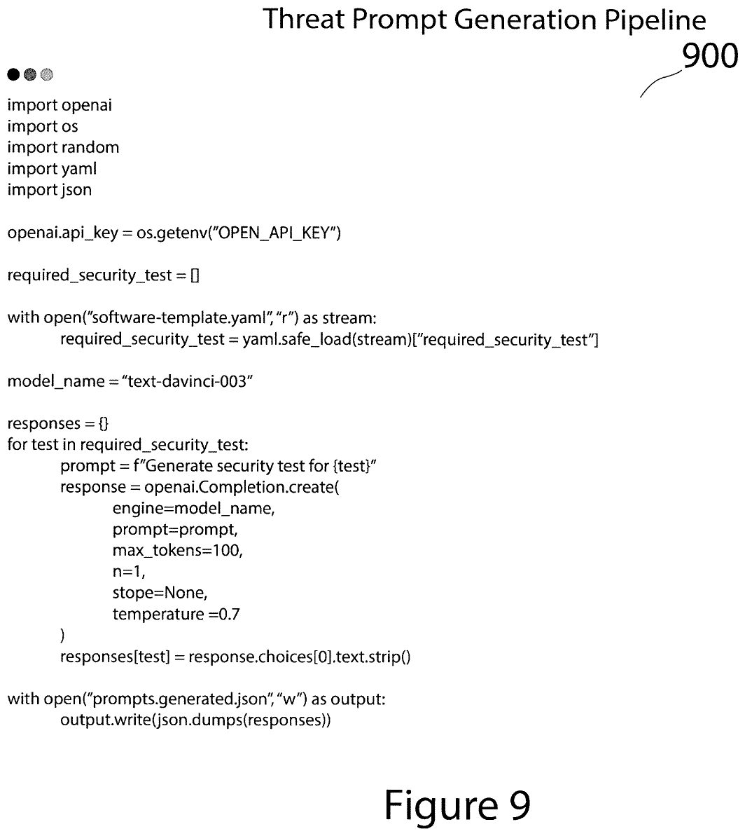

Referring to FIG. 9, there is shown an embodiment of a threat prompt generation pipeline, which is akin to prompt generation pipeline 134 depicted in FIG. 1.

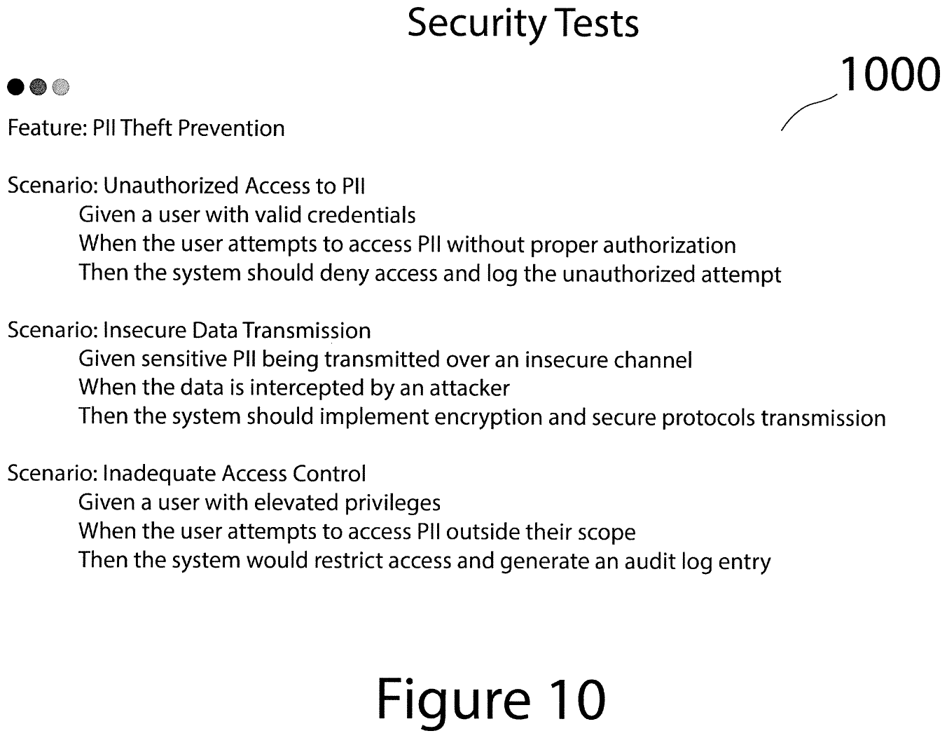

Referring to FIG. 10, there is shown an embodiment of a security test 1000 provided in a Given-When-Then format. The format of security test 1000 may be ingested or used by a large language model to further improve threat modeling in a continuous automatic threat modeling system.

### General

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated. A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A system for continuous automated threat modeling based on prompt engineering using large language models, the system comprising:
a threat modeling engine configured to ingest an application profile, a workload context, and a software template,
wherein the threat modeling engine generates a threat model after ingesting the application profile, the workload context, and the software template;
a threat prompt generator comprising a prompt generation pipeline,
wherein the prompt generation pipeline is integrated with a large language model and generates a threat prompt, wherein the threat prompt is based off an annotated threat configuration from a threat data annotator, a threat taxonomy, and a prompt template; and
a continuous automation module, wherein the continuous automation module retrieves the threat prompt and performs a security assessment of the threat prompt.

2. The system as claimed in claim 1, further comprising a threat artifact generator in communication with the threat modeling engine.

3. The system as claimed in claim 1, wherein the annotated threat configuration comprises a third-party threat intelligence program.

4. The system as claimed in claim 1, wherein the continuous automation module further comprises a code generator in communication with the large language model.

5. The system as claimed in claim 1, wherein the threat modeling engine further comprises a threat engine orchestrator in communication with a threat configuration composer, one or more threat artifacts, and a Relative Attacker Attractiveness analyzer.

6. The system as claimed in claim 5, wherein the threat modeling engine generates the one or more threat artifacts and the Relative Attacker Attractiveness analyzer.

7. The system as claimed in claim 5, wherein the Relative Attacker attractiveness analyzer receives information from a threat and risk catalog and the threat engine orchestrator, analyzes the information, generates a percentage value, then sends the percentage value to a threat score generator.

8. The system as claimed in claim 1, wherein the threat prompt generator further comprises a prompt template composer configured to compose a threat prompt template, save the threat prompt template in a threat template repository, obtain an annotation from a threat data annotator, communicate with a threat taxonomy database, and send information to a prompt generation pipeline.

9. The system as claimed in claim 8, wherein the prompt generation pipeline configures the threat prompt to query and train the large language model.

10. The system as claimed in claim 1, wherein the continuous automation module further comprises a policy generator in communication with the large language model.

11. The system as claimed in claim 1, wherein the continuous automation module further comprises automatic and continuous generation of at least one threat report that is communicated to the threat modeling engine.

12. The system as claimed in claim 1, wherein the large language model is integrated with a policy generator and a code generator.

13. The system as claimed in claim 1, wherein the continuous automation module further comprises the large language model developing policies and code via queries and training from prior threat reports and/or prior threat prompts.

14. The system as claimed in claim 1, wherein the continuous automation module further comprises a template patching notification.

15. A method for continuous automated threat modeling based on prompt engineering using large language models, the method comprising:
ingesting an application profile, a workload context, and a software template;
identifying potential threats and vulnerabilities of a system;
annotating a threat configuration;
incorporating data that mitigates the potential threats and vulnerabilities of the system;
generating a threat prompt based off an annotated threat configuration, a threat taxonomy, a prompt template, and prompt engineering;
integrating a large language model; and
enabling continuous automation of the system via automatic retrieval of the threat prompt and automatic performance of a security assessment on the threat prompt.

16. The method as claimed in claim 15, further comprising generating threat artifacts based on the identified potential threats and vulnerabilities of the system.

17. The method as claimed in claim 15, wherein the threat prompt is based on fine-tuning, a sampling strategy, and a diversity algorithm.

18. A computer-readable medium storing instructions that, when executed by a computing device, causes the device to perform a method for continuous automated threat modeling based on prompt engineering using large language models, the method comprising:
ingesting an application profile, a workload context, and a software template;
identifying potential threats and vulnerabilities of a system;
annotating a threat configuration;
incorporating data that mitigates the potential threats and vulnerabilities of the system;
generating a threat prompt based off an annotated threat configuration, a threat taxonomy, a prompt template, and prompt engineering;
integrating a large language model; and
enabling continuous automation of the system via automatic retrieval of the threat prompt and automatic performance of a security assessment on the threat prompt.
